(19) United States
(12) Patent Application Publication
(10) Pub. No.: US 2003/0224142 A1
(43) Pub. Date: Dec. 4, 2003

(54) Methods for making slot cell insulation and slot cell insulation produced thereby

(75) Inventor: Mark Lee Miller, Orlando, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 10/158,955

(22) Filed: May 31, 2002

(51) Int. Cl. B32B 3/04

(52) U.S. Cl. 428/122

(57) ABSTRACT

A method is for making slot cell insulation 20 for positioning in a rotor slot between rotor windings 17 and adjacent portions of the rotor 16 of a dynamoelectric machine 15. The method may include providing a male mold 51 having an outer shape corresponding to the rotor slot, stacking a plurality of layers adjacent the male mold, and laminating the stacked layers together on the male mold to thereby form the slot cell insulation 29. The stacked layers may include a pair of aromatic polyamide layers 32a, 32b and a polyimide layer 33 therebetween. These layers may be prelaminated, that is, laminated together prior to the overall lamination of the layers. Each aromatic polyamide layer 32a, 32b may be NOMEX® 410 paper, for example. In addition, the polyimide layer 33 may be a corona-resistant polyimide layer, such as a KAPTON® CR layer.

### FIELD OF THE INVENTION

The present invention relates to the field of electrical power generators and motors, and, more particularly, to insulation for such devices and associated methods.

### BACKGROUND OF THE INVENTION

A commercial electrical power generator typically includes a rotor and a stator which surrounds the rotor. The rotor is mounted on a shaft which is driven by a steam turbine or combustion turbine, for example. The rotor typically includes a forged body including slots therein, and windings are positioned in the slots. An exciter delivers electrical power to the windings so that the rotor generates a rotating magnetic flux which cuts through corresponding windings in the stator to thereby produce electrical power.

The rotor windings are typically insulated from the adjacent portions of the rotor body by an insulating body typically formed of a number of layers laminated together and shaped to be received in the generally U-shaped rotor slot. U.S. Pat. No. 5,164,142 to Simmonds, for example, discloses a process and apparatus for step molding elongated pieces, such as rotor slot cell insulation.

The slot cell insulation typically includes openings therein to receive a radial flow of cooling air or hydrogen to thereby cool the windings. For example, U.S. Pat. No. 4,560,896 to Vogt et al. discloses a composite insulation comprising aramid paper slot armor and an epoxy-glass sub-slot cover.

A static excitation system may be used to power the rotor, and this may place additional stress on the slot cell insulation. The static excitation system typically includes a static exciter which is an electronic device including semiconductor switches to generate the DC current for the rotor, but also including an AC component. The static exciter has an input connected to an exciter transformer, and its output is coupled to the rotor windings via brush rigging and a coupling ring assembly. Static excitation is advantageous because it is relatively simple, has no rotating parts, has a fast response time, and has a relatively compact size. The disadvantage is that the slot cell insulation and other rotor components are subject to repetitive voltage pulses of substantial amplitude.

The assignee of the present invention has provided slot cell insulation formed of five stacked layers including an inner TEFLON®-glass layer (0.005″), an epoxy-glass prepreg layer (0.010″), a NOMEX® 410 layer (0.010″), an epoxy-glass prepreg layer (0.010″), and an outer NOMEX® 410 layer (0.010″).

The slot cell insulation is typically made by laying up the layers on a flat surface and then positioning the layers in a female mold having the shape of the rotor slot. Slip between the layers is relatively.limited so that wrinkles may be formed at the corners or bends. A male mold is pressed into the layers so that the layers take the desired U-shape of the slot. Unfortunately, the layers may also be stretched at the corners by this molding technique also producing defects in the slot cell insulation.

### SUMMARY OF THE INVENTION

In view of the foregoing background, it is therefore an object of the invention to provide high quality slot cell insulation and a method for making the slot cell insulation that is better able to resist heat and/or electrical deterioration.

This and other objects, features and advantages in accordance with the invention are provided by a method for making slot cell insulation comprising providing a male mold having an outer shape corresponding to the rotor slot; stacking a plurality of layers adjacent the male mold; and laminating the stacked layers together on the male mold to thereby form the slot cell insulation. The slot cell insulation can then be removed from the male mold. The male mold may have a generally U-shaped outer surface. Accordingly, corner portions of the slot cell insulation can be made more uniform and with a greatly reduced likelihood of defects.

The laminating may include heating the stacked layers. In addition, the stacked layers may comprise at least one heat curable layer having a heat curing temperature, and heating may comprise heating to at least the heat curing temperature. For example, the at least one heat curable layer may be an epoxyglass prepreg layer.

Laminating may also comprise covering the stacked layers with an evacuable membrane, and evacuating the evacuable membrane to thereby press the stacked layers together and remove volatile materials therefrom. This vacuum pressing may be performed prior to heating and/or during heating, for example. The laminating may further include subjecting the evacuable membrane to an elevated pressure to further press the stacked layers together.

Other important aspects of the invention relate to the layers used in making the slot cell insulation. The stacked layers may comprise a pair of aromatic polyamide layers and a polyimide layer therebetween. These layers may be prelaminated, that is, laminated together prior to the overall lamination of the layers. Each aromatic polyamide layer may comprise NOMEX® paper, for example. In addition, the polyimide layer may be a corona-resistant polyimide layer, such as a KAPTON® CR layer. The NOMEX® layers provide a protective sandwich for the relatively mechanically fragile KAPTON® CR layer.

The stacked layers may also comprise one or more epoxy-glass prepreg layers. A polytetrafluoroethylene (PTFE)-glass layer may be included in the stacked layers and be positioned so that the PTFE portion engages the rotor windings when installed. The stacked layers may also include an additional aromatic polyamide layer positioned to engage the rotor.

The invention is also directed to a method for making slot cell insulation including providing a mold having a shape corresponding to the rotor slot; and laminating a plurality of stacked layers together adjacent the mold to thereby form the slot cell insulation, and wherein the stacked layers comprise a pair of aromatic polyamide layers and a polyimide layer therebetween. In words, in accordance with this aspect of the invention the unique material combination may be used for any molding/laminating approach.

Yet another aspect of the invention is directed to the slot cell insulation. More particularly, the slot cell insulation may include a laminated structure for positioning in the rotor slot and comprising a plurality of layers laminated together. The plurality of layers, in turn, may comprise a pair of aromatic polyamide layers and a polyimide layer therebetween.

### BRIEF DESCRIPTION OF THE DRAWINGS

FIG. 1 is a fragmentary perspective view of a portion of a dynamoelectric machine including the slot cell insulation in accordance with the present invention.

FIG. 2 is a greatly enlarged cross-sectional view of a portion of the slot cell insulation as shown in FIG. 1.

FIG. 3 is a schematic cross-sectional view during manufacturing of the slot cell insulation as shown in FIG. 1.

FIG. 4 is a flow chart for a method of making the slot cell insulation as shown in FIG. 1.

FIG. 5 is a flow chart for an alternate method of making the slot cell insulation as shown in FIG. 1.

FIG. 6 is graph of comparative test results for the slot cell insulation as shown in FIG. 1.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout.

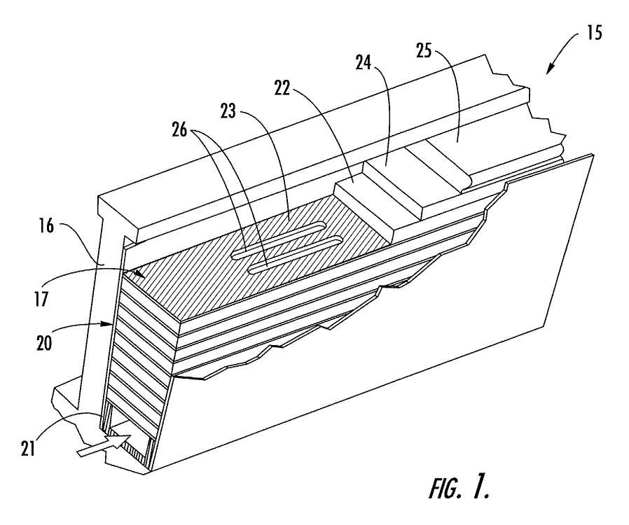

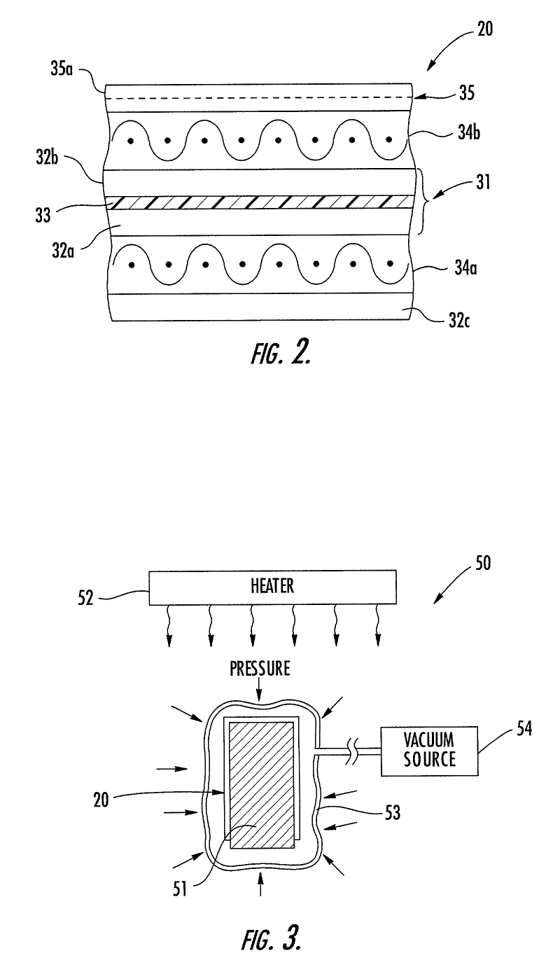

Referring now initially to FIGS. 1 and 2 the slot cell insulation 20 in accordance with the invention is first described. The slot cell insulation 20 is positioned in a rotor slot between rotor windings 17 and adjacent rotor portions 16 of a dynamoelectric machine 15. The dynamoelectric machine may be either a motor or generator as will be readily appreciated by those skilled in the art.

In the illustrated embodiment, the dynamoelectric machine 15 also includes a cooling gas channel member 21 positioned beneath a stacked arrangement of rotor coil copper layers 22 and rotor turn insulation 23. A filler insulation block 24 is positioned over the uppermost copper layer, and a wedge 25 secures the windings 17 within the rotor slot. The gas channel member 21 is connected in fluid communication with radial slots 26 in the windings 17 to pass cooling fluid therethrough. Other winding configurations are also contemplated by the present invention.

The illustrated slot cell insulation 20 includes a plurality of layers stacked and laminated together. Of particular advantage is the inclusion of a prelaminated layer 31 which, in turn, includes a pair of aromatic polyamide layers 32a, 32b and a polyimide layer 33 therebetween. These layers may preferably be prelaminated, that is, laminated together prior to the overall lamination of the remaining layers of the insulation 20. The prelaminated layer 31 is advantageous in that the outer aromatic polyamide layers 32a, 32b provide mechanical strength and protection for the inner polyimide layer 33. The polyimide layer 33 has very desirable electrical characteristics, but is typically relatively expensive and easily damaged if handled by itself.

Each aromatic polyamide layer 32a, 32b may comprise NOMEX® 410 paper, for example. In addition, the polyimide layer 33 may be a KAPTON® layer. More preferably, the polymide layer 33 may be a corona-resistant polyimide layer, such as a KAPTON® CR layer. The external surfaces of the prelaminated arrangement advantageously provide the same bonding surfaces (NOMEX® 410 paper) as the prior art. Both the NOMEX® and KAPTON® CR materials are available from DuPont. Other similar materials may also be used in the slot cell insulation 20 as will be appreciated by those skilled in the art.

Using selected high Tg thermoplastic polymer films can increase the ultimate withstand voltage stress and voltage endurance of the slot cell insulation 20. Important thermal conductivity improvement can also be realized. These high performance polymer films, like corona resistant KAPTON® CR are relatively expensive and difficult handle in large sheet form. These polymer films are typically very thin and fragile where dents, wrinkles, pinholes, or contamination can readily occur during slot cell stack-up prior to molding. The preferred polymer film application method is a prelaminate of the polymer film between opposed layers of NOMEX®. This prelaminated material made before slot cell stack-up for molding will prevent film damage and provide easy to handle sheet insulation. Also, the polymer film can be pretreated with corona discharges or heat treated to promote chemical adhesion in the lamination line prior to laminating. The laminating adhesive in the prelaminate is for high temperature applications including the polymer film-NOMEX® interface bonding.

The slot cell insulation 20 illustratively includes first and second epoxy-glass prepreg layers 34a, 34b adjacent respective opposite sides of the laminated layer 31. A polytetrafluoroethylene (PTFE)-glass layer 35 is included in the stacked layers and is positioned so that the PTFE portion 35a engages the rotor windings 17 when installed. The PTFE portion 35a facilitates desired slippage between the windings 17 and slot cell insulation 20. The slot cell insulation 20 also includes an additional aromatic polyamide layer 32c, such as NOMEX® 410 paper, positioned to engage the rotor 16. As will be readily appreciated by those skilled in the art, the epoxy-glass prepreg layers 34a, 34b are heat curable layers that serve to bind the adjacent layers together.

The starting thickness for the various layers may be as follows: PTFE-glass layer 35 about 0.005 inches, epoxy-glass prepreg layers 34a, 34b about 0.010 inches, aromatic polyamide layers 32a-32c about 0.005 inches, and the inner polyimide layer 33 about 0.0015 inches. Of course, for better thermal conductance these thicknesses may be reduced, while for better electrical insulation the thicknesses may be greater. Use of the prelaminated layer 31 allows the overall thickness to be reduced while maintaining the mechanical strength and voltage endurance. Those of skill in the art will appreciate that the desired thicknesses are somewhat application specific. It is noted, however, that the listed materials and thicknesses should meet the new Class H requirements for operation up to 180° C. During laminating, the stacked layers may experience a decrease in total thickness from the starting 0.055 inches down to about 0.045 inches, for example.

With thinner starting layers and/or additional pressure the resulting thickness may also be reduced down to 0.030 to 0.035 inches as will be appreciated by those skilled in the art. Thinner slot cell insulation 20 may permit more copper and, hence, more current carrying capacity for the rotor windings. Thicker slot cell insulation 20 may be readily produced by including additional epoxy-glass prepreg and NOMEX® layers on either or both sides of the prelaminated central layer 31, for example, as will also be appreciated by those skilled in the art.

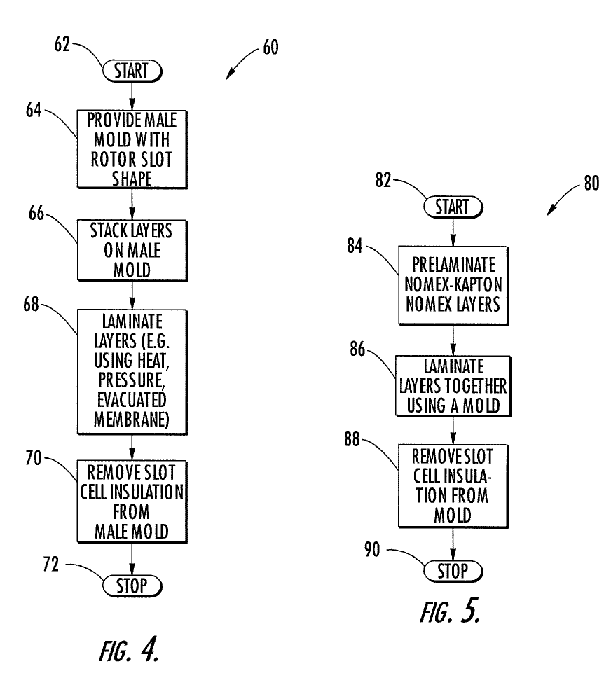

Turning now additionally to the apparatus 50 of FIG. 3 and the flow chart 60 of FIG. 4, methods of making the slot cell insulation 20 are now described. From the start (Block 62), the method illustratively includes at Block 64 providing a male mold 51 having an outer shape corresponding to the rotor slot. At Block 66 the layers for the slot cell insulation 20 are stacked onto the male mold 51. A release layer, not shown, may be provided to facilitate later release from the mold 51 as will be appreciated by those skilled in the art. At Block 68 the stacked layers are laminated together on the male mold 51 to thereby form the slot cell insulation 20. The slot cell insulation 20 can then be removed from the male mold 51 (Block 70) before stopping at Block 72.

As shown in the illustrated apparatus 50, the male mold 51 may have a generally U-shaped outer surface (shown in inverted position in FIG. 3) so that corner portions of the slot cell 20 insulation can be made more uniform and with a greatly reduced likelihood of defects. In other words, unlike the prior art which assembles the layers first on a flat surface and then bends the layers into a female mold, the layers are laid up on the male mold 51. Also according to the prior art, positioning of the male mold within the female mold would tend to cause non-uniformities at the corners. The present invention also addresses this shortcoming as will be appreciated by those skilled in the art. Another advantage of using the male mold 51 in this embodiment of manufacturing is that the cost and lead time for a female mold can be avoided.

The laminating may include heating the stacked layers, such as by using the schematically illustrated heater 52 of the apparatus 50. Of course, the stacked layers may comprise at least one heat curable layer having a heat curing temperature, and heating may comprise heating to at least the heat curing temperature. For example, the at least one heat curable layer may be an epoxy-glass prepreg layer. The heating may include an initial upward ramping of about 5° C./minute until reaching a temperature of about 175-185° C. This heating may be maintained for about 1 to 4 hours, prior to a cool down cycle.

Laminating may also comprise covering the stacked layers with an evacuable membrane 53, and evacuating the evacuable membrane via the schematically illustrated vacuum source 54 to thereby press the stacked layers together and remove volatile materials therefrom. A felt breathing layer, not shown, may be provided between the stacked layers and the evacuable membrane 53 as will also be appreciated by those skilled in the art. This vacuum pressing may be performed prior to heating and/or during heating, for example.

The laminating may further include subjecting the evacuable membrane 53 to an elevated externally applied pressure to further press the stacked layers together. The pressure may be provided by an inert gas or a layer of shrink tape (not shown) and range from about 50 to 300 psi, and, more preferably about 85 to 100 psi. Other pressure and temperature ranges may be used depending upon the materials for the slot cell insulation 20 as will be appreciated by those skilled in the art. The vacuum and pressure may cause the resin of the epoxy-glass prepreg layer to saturate the adjacent NOMEX® paper layers, for example.

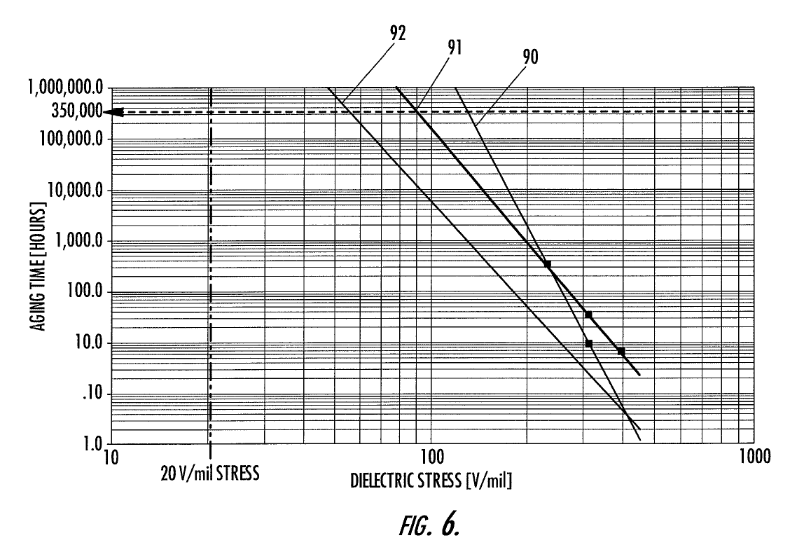

Turning now additionally to the flow chart 80 of FIG. 5, and as noted above, another important aspect of the method relates to the material layers used to make the slot cell insulation 20. In particular, the stacked layers may preferably comprise a pair of aromatic polyamide layers and a polyimide layer therebetween. More particularly, from the start (Block 82), the stacked layers may include a prelaminated NOMEX®-KAPTON® CR-NOMEX® layer 31 (Block 84). This prelaminated arrangement 31 may then be positioned adjacent a mold (male or female, although a male mold 51 may be preferred) and laminated together at Block 86. The slot cell insulation 20 may then be removed from the mold at Block 88 before stopping at Block 90.

The slot cell insulation 20 and associated manufacturing methods provide a number of advantages. For example, improved voltage endurance, thermal conductivity, and thermal conductance are achieved. Warpage and moisture sensitivity may also be reduced. The mechanical properties are equal to or better than existing slot cell insulation. The slot cell insulation may also meet the more stringent Class H requirements, and/or may be more desirable in applications using static excitation. The molding time may also be reduced to provide additional cost savings.

In other embodiments, a central laminate structure including the following may be used: polymer film-mica paper-polymer film; NOMEX®-polymer film-NOMEX®; and Dacron-PET-Dacron. A number of thermoplastic polymer films may be used including: polyetherimide (PEI), polyether ether keytone (PEEK), polyimide (PI), high performance polyethylene terephtalate (PET), and DACRON®-MYLAR®-DACRON® (DMD) polyester felt-polyester film laminate. In other embodiments a mica-epoxy/glass structure may be used. For some applications, the mica paper may provide reduced mechanical qualities from those typically desired for slot cell insulation. The mica paper embodiments do, however, enjoy excellent electrical properties.

The plots of FIG. 6 illustrate the comparative aging time versus dielectric stress for various slot cell configurations. The plot labeled 91 is for the seven-layer construction described above and including the NOMEX®-KAPTON® CR-NOMEX® central portion, and the plot labeled 90 is for a mica-epoxy/glass central portion. The plot labeled 92 is for a conventional NOMEX®-epoxy/glass construction.

Many modifications and other embodiments of the invention will come to the mind of one skilled in the art having the benefit of the teachings presented in the foregoing descriptions and the associated drawings. Accordingly, it is understood that the invention is not to be limited to the illustrated embodiments disclosed, and that other modifications and embodiments are intended to be included within the spirit and scope of the appended claims.

That which is claimed is:

1. A method for making slot cell insulation for positioning in a rotor slot between rotor windings and adjacent rotor portions of a dynamoelectric machine, the method comprising:
providing a male mold having an outer shape corresponding to the rotor slot;
stacking a plurality of layers adjacent the male mold; and
laminating the stacked layers together on the male mold to thereby form the slot cell insulation; and
removing the slot cell insulation from the male mold.

2. A method according to claim 1 wherein laminating comprises heating the stacked layers.

3. A method according to claim 2 wherein the stacked layers comprise at least one heat curable layer having a heat curing temperature; and wherein heating comprises heating to at least the heat curing temperature.

4. A method according to claim 2 wherein the at least one heat curable layer comprises an epoxy-glass prepreg layer.

5. A method according to claim 1 wherein laminating comprises:
covering the stacked layers with an evacuable membrane; and
evacuating the evacuable membrane to thereby press the stacked layers together and remove volatile materials therefrom.

6. A method according to claim 5 wherein laminating further comprises heating the stacked layers; and wherein the covering and evacuating are performed during heating.

7. A method according to claim 5 wherein laminating further comprises heating the stacked layers; and wherein the covering and evacuating are performed prior to heating.

8. A method according to claim 5 wherein laminating further comprises subjecting the evacuable membrane to an elevated pressure to further press the stacked layers together.

9. A method according to claim 1 wherein the stacked layers comprise a pair of aromatic polyamide layers and a polyimide layer therebetween.

10. A method according to claim 9 further comprising laminating the pair of aromatic polyamide layers and polyimide layer therebetween prior to stacking.

11. A method according to claim 9 wherein each aromatic polyamide layer comprises NOMEX® paper.

12. A method according to claim 9 wherein the polyimide layer comprises a corona-resistant polyimide layer.

13. A method according to claim 12 wherein the corona-resistant polyimide layer comprises a KAPTON® CR layer.

14. A method according to claim 1 wherein the stacked layers comprise at least one epoxy-glass prepreg layer.

15. A method according to claim 1 wherein the stacked layers comprise a polytetrafluoroethylene (PTFE)-glass layer positioned so that the PTFE portion engages the rotor windings.

16. A method according to claim 1 wherein the stacked layers comprise an aromatic polyamide layer positioned to engage the rotor.

17. A method according to claim 1 wherein the male mold has a generally U-shaped outer surface.

18. A method for making slot cell insulation for positioning in a rotor slot between rotor windings and adjacent rotor portions of a dynamoelectric machine, the method comprising:
providing a mold;
laminating a plurality of stacked layers together adjacent the mold to thereby form the slot cell insulation, the stacked layers comprising a pair of aromatic polyamide layers and a polyimide layer therebetween; and
removing the slot cell insulation from the mold.

19. A method according to claim 18 wherein the mold comprises a male mold.

20. A method according to claim 18 wherein laminating comprises heating the stacked layers.

21. A method according to claim 20 wherein laminating further comprises:
covering the stacked layers with an evacuable membrane; and
evacuating the evacuable membrane to thereby press the stacked layers together and remove volatile materials therefrom.

22. A method according to claim 21 wherein laminating further comprises subjecting the evacuable membrane to an elevated pressure.

23. A method according to claim 18 further comprising laminating the pair of aromatic polyamide layers and polyimide layer therebetween prior to laminating the layers together adjacent the mold.

24. A method according to claim 18 wherein each aromatic polyamide layer comprises NOMEX® paper; and wherein the polyimide layer comprises a KAPTON® CR layer.

25. A method according to claim 18 wherein the stacked layers comprise a polytetrafluoroethylene (PTFE)-glass layer positioned so that the PTFE portion engages the rotor windings.

26. A method according to claim 18 wherein the stacked layers comprise an additional aromatic polyamide layer positioned to engage the rotor.

27. Slot cell insulation for positioning in a rotor slot between rotor windings and adjacent rotor portions of a dynamoelectric machine, the slot cell insulation comprising:
a laminated structure for positioning in the rotor slot and comprising a plurality of layers laminated together;
said plurality of layers comprising a pair of aromatic polyamide layers and a polyimide layer therebetween.

28. Slot cell insulation according to claim 27 wherein each aromatic polyamide layer comprises NOMEX® paper.

29. Slot cell insulation according to claim 27 wherein each aromatic polyamide layer has a thickness of not greater than about 0.005 inches.

30. Slot cell insulation according to claim 27 wherein said polyimide layer comprises a corona-resistant polyimide layer.

31. Slot cell insulation according to claim 30 wherein said corona-resistant polyimide layer comprises a KAPTON® CR layer.

32. Slot cell insulation according to claim 27 wherein said polyimide layer has a thickness not greater than about 0.0015 inch.

33. Slot cell insulation according to claim 27 wherein said layers comprise at least one epoxy-glass prepreg layer.

34. Slot cell insulation according to claim 27 wherein said layers comprise a polytetrafluoroethylene (PTFE)-glass layer positioned so that the PTFE portion engages the rotor windings.

35. Slot cell insulation according to claim 27 wherein said layers comprise an additional aromatic polyamide layer positioned to engage the rotor.

36. Slot cell insulation according to claim 27 wherein said laminated structure is generally U-shaped.
